(19) United States
(12) Patent Application Publication
(10) Pub. No.: US 2004/0054011 A1
(43) Pub. Date: Mar. 18, 2004

(54) Fungicidal mixtures

(76) Inventors: Thomas Grote, Wachensheim (DE); Ingo Rose, Mannheim (DE); Eberhard Ammermann, Heppenheim (DE); Reinhard Stierl, Mutterstadt (DE); Gisela Lorenz, Hambach (DE); Siegfried Strathmann, Limburgerhof (DE); Maria Scherer, Landau (DE); Klaus Schelberger, Gonnheim (DE); Egon Haden, Kleinniedesheim (DE)

Correspondence Address: KEIL & WEINKAUF, 1350 CONNECTICUT AVENUE, N.W., WASHINGTON, DC, 20036, US

(21) Appl. No.: 10/466,167

(22) PCT Filed: Jan. 17, 2002
(86) PCT No.: PCT/EP02/00412

(30) Foreign Application Priority Data
Jan. 18, 2001 (DE) 101 17 260.5

(51) Int. Cl. A01N 37/18; A01N 35/00

(52) U.S. Cl. 514/619; 514/679

(57) ABSTRACT

Fungicidal mixtures, comprising

a) benzophenones of the formula I,

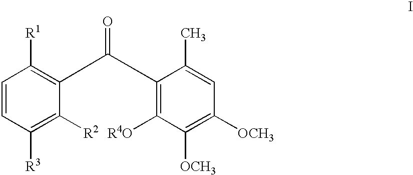

in which

R¹ is chlorine, methyl, methoxy, acetoxy, pivaloyloxy or hydroxyl;

R² is chlorine or methyl;

R³ is hydrogen, halogen or methyl; and

R⁴ is C₁-C₆-alkyl or benzyl, where the phenyl moiety of the benzyl radical may carry a halogen or methyl substituent, and

b) trisoxime ethers of the formula II,

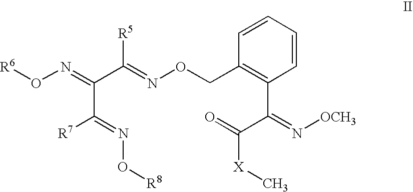

in which the substituents are as defined below:

X is NH or oxygen;

R⁵, R⁷ independently of one another are C₁-C₄-alkyl or cyclopropyl;

R⁶, R⁸ independently of one another are C₁-C₄-alkyl, C₃-C₄-alkenyl or cyclopropyl;

in a synergistically effective amount, methods for controlling harmful fungi using mixtures of compounds I and II and compositions comprising them are described.

The present invention relates to fungicidal mixtures, comprising

a) benzophenones of the formula I,

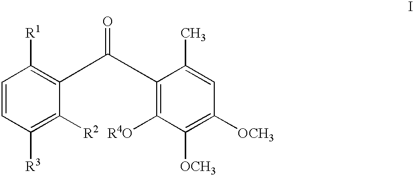

in which

R¹ is chlorine, methyl, methoxy, acetoxy, pivaloyloxy or hydroxyl;

R² is chlorine or methyl;

R³ is hydrogen, halogen or methyl; and

R⁴ is C₁-C₆-alkyl or benzyl, where the phenyl moiety of the benzyl radical may carry a halogen or methyl substituent, and

b) trisoxime ethers of the formula II,

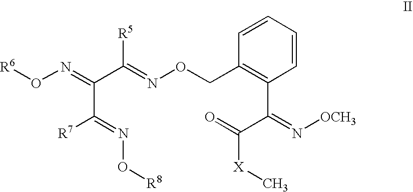

in which the substituents are as defined below:

X is NH or oxygen;

R⁵, R⁷ independently of one another are C₁-C₄-alkyl or cyclopropyl;

R⁶, R⁸ independently of one another are C₁-C₄-alkyl, C₃-C₄-alkenyl or cyclopropyl;

in a synergistically effective amount.

Moreover, the invention relates to methods for controlling harmful fungi using mixtures of the compounds I and II and compositions conditioned in two parts.

The compounds of the formula I, their preparation and their action against harmful fungi are known from the literature (EP-A 727 141; EP-A 897 904; EP-A 899 255; EP-A 967 196).

Mixtures of benzophenones of the formula I with other fungicidally active compounds are known from EP-A 1 023 834.

The trisoxime ethers of the formula II, their preparation and their action against harmful fungi are known (EP-A 876 332).

A possible synergism between the specifically substituted benzophenones of the formula I and the trisoxime ethers of the formula II has hitherto been unknown.

It is an object of the present invention to provide mixtures which have an improved activity against harmful fungi combined with a reduced total amount of active compounds applied (synergistic mixtures), with a view to reducing the application rates and improving the activity spectrum of the known compounds I and II.

We have found that this object is achieved by the mixture defined at the outset. Moreover, we have found that applying the compounds I and the compounds II simultaneously, i.e. together or separately, or applying the compounds I and the compounds II in succession provides better control of harmful fungi than is possible with the individual compounds alone.

The following compounds of the formula I are preferred mixing partners, the individual preferences applying on their own and in combination.

Preference is given to compounds I in which R¹ is chlorine, methoxy, acetoxy or hydroxyl, and particular preference is given to compounds in which R¹ is methoxy, acetoxy or hydroxyl. Very particular preference is given to compounds in which R¹ is methoxy.

Mixtures comprising compounds I in which R² is chlorine or methyl are mixtures according to the invention. Preference is given to compounds I in which R² is methyl.

Moreover, preference is given to compounds I in which R³ is hydrogen, methyl, chlorine or bromine and particularly preferably hydrogen, chlorine or bromine.

In addition, preference is given to compounds I in which R⁴ is C₁-C₄-alkyl or benzyl, where the phenyl moiety of the benzyl radical may carry a halogen or methyl substituent. Particular preference is given to compounds of the formula I in which R⁴ is C₁-C₄-alkyl and preferably methyl.

Furthermore preferred are compounds of the formula I in which the substituents R¹, R², R³ and R⁴ are as defined below:

R¹ is methoxy, acetoxy or hydroxyl;

R² is methyl;

R³ is hydrogen, chlorine or bromine; and

R⁴ is C₁-C₄-alkyl.

In addition, particular preference is given to compounds of the formula I in which the substituents have the meanings given in the table below:

| | |
|---|---|
| | I |
| 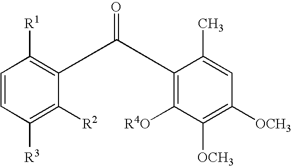 | |

| No. | R¹ | R² | R³ | R⁴ |
|---|---|---|---|---|
| I-1 | methoxy | Cl | H | methyl |
| I-2 | methoxy | Cl | methyl | methyl |
| I-3 | methoxy | Cl | H | n-propyl |
| I-4 | methoxy | Cl | H | n-butyl |
| I-5 | methoxy | Cl | H | benzyl |
| I-6 | methoxy | Cl | H | 2-fluorobenzyl |
| I-7 | methoxy | Cl | H | 3-fluorobenzyl |
| I-8 | methoxy | Cl | H | 4-fluorophenyl |
| I-9 | methoxy | Cl | H | 2-methylphenyl |
| I-10 | methoxy | Cl | H | 3-methylphenyl |
| I-11 | methoxy | Cl | H | 4-methylphenyl |
| I-12 | methoxy | Cl | Br | methyl |
| I-13 | methoxy | Cl | Br | n-propyl |
| I-14 | methoxy | Cl | Br | n-butyl |
| I-15 | methoxy | Cl | Br | benzyl |
| I-16 | methoxy | Cl | Br | 2-fluorobenzyl |
| I-17 | methoxy | methyl | H | methyl |
| I-18 | methoxy | methyl | Cl | methyl |
| I-19 | methoxy | methyl | H | n-propyl |
| I-20 | methoxy | methyl | H | n-butyl |
| I-21 | methoxy | methyl | H | benzyl |
| I-22 | methoxy | methyl | H | 2-fluorobenzyl |
| I-23 | methoxy | methyl | H | 3-fluorobenzyl |
| I-24 | methoxy | methyl | H | 4-fluorophenyl |
| I-25 | methoxy | methyl | H | 2-methylphenyl |
| I-26 | methoxy | methyl | H | 3-methylphenyl |
| I-27 | methoxy | methyl | H | 4-methylphenyl |
| I-28 | methoxy | methyl | Br | methyl |
| I-29 | methoxy | methyl | Br | n-propyl |
| I-30 | methoxy | methyl | Br | n-butyl |
| I-31 | methoxy | methyl | Br | benzyl |
| I-32 | methoxy | methyl | Br | 2-fluorobenzyl |
| I-33 | acetoxy | methyl | H | methyl |
| I-34 | acetoxy | methyl | Cl | methyl |
| I-35 | acetoxy | methyl | Br | methyl |
| I-36 | hydroxy | methyl | H | methyl |
| I-37 | hydroxy | methyl | Cl | methyl |
| I-38 | hydroxy | methyl | Br | methyl |
| I-39 | pivaloyloxy | methyl | H | methyl |
| I-40 | pivaloyloxy | methyl | Cl | methyl |
| I-41 | pivaloyloxy | methyl | Br | methyl |
| I-42 | Cl | Cl | H | methyl |
| I-43 | Cl | Cl | H | n-propyl |
| I-44 | Cl | Cl | H | n-butyl |
| I-45 | Cl | Cl | H | benzyl |
| I-46 | Cl | Cl | H | 2-fluorobenzyl |
| I-47 | Cl | Cl | H | 3-fluorobenzyl |
| I-48 | Cl | Cl | H | 4-fluorophenyl |
| I-49 | Cl | Cl | H | 2-methylphenyl |
| I-50 | Cl | Cl | H | 3-methylphenyl |
| I-51 | Cl | Cl | H | 4-methylphenyl |
| I-52 | Cl | Cl | Br | methyl |
| I-53 | Cl | Cl | Br | n-propyl |
| I-54 | Cl | Cl | Br | n-butyl |
| I-55 | Cl | Cl | Br | benzyl |
| I-56 | Cl | Cl | Br | 2-fluorobenzyl |
| I-57 | methyl | methyl | H | methyl |
| I-58 | methyl | methyl | H | n-propyl |
| I-59 | methyl | methyl | H | n-butyl |
| I-60 | methyl | methyl | H | benzyl |
| I-61 | methyl | methyl | H | 2-fluorobenzyl |
| I-62 | methyl | methyl | H | 3-fluorobenzyl |
| I-63 | methyl | methyl | H | 4-fluorophenyl |
| I-64 | methyl | methyl | H | 2-methylphenyl |
| I-65 | methyl | methyl | H | 3-methyiphenyl |
| I-66 | methyl | methyl | H | 4-methylphenyl |
| I-67 | methyl | methyl | Br | methyl |
| I-68 | methyl | methyl | Br | n-propyl |
| I-69 | methyl | methyl | Br | n-butyl |
| I-70 | methyl | methyl | Br | benzyl |
| I-71 | methyl | methyl | Br | 2-fluorobenzyl |

With a view to their use in the mixtures according to the invention, preference is given to the trisoxime ethers II compiled in Table 2 below.

TABLE 2

| | |
|---|---|
| | II |
| 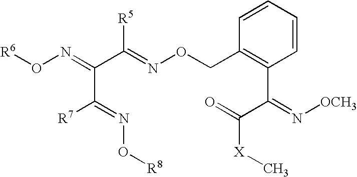 | |

| No. | R⁵ | R⁶ | R⁷ | R⁸ | X |
|---|---|---|---|---|---|
| II-1 | CH₃ | CH₃ | CH₃ | CH₃ | NH |
| II-2 | CH₃ | cyclo-C₃H₅ | CH₃ | cyclo-C₃H₅ | NH |
| II-3 | CH₃ | CH₂CH₃ | CH₃ | CH₂CH₃ | NH |
| II-4 | CH₃ | CH(CH₃)2 | CH₃ | CH(CH₃)2 | NH |
| II-5 | CH₃ | CH₂CH═CH₂ | CH₃ | CH₂CH═CH₂ | NH |
| II-6 | CH₃ | cyclo-C₃H₅ | CH₃ | cyclo-C₃H₅ | O |
| II-7 | CH₃ | CH₂CH₃ | CH₃ | CH₂CH₃ | O |
| II-8 | CH₃ | CH(CH₃)2 | CH₃ | CH(CH₃)2 | O |
| II-9 | CH₃ | CH₂CH═CH₂ | CH₃ | CH₂CH═CH₂ | O |

Particular preference is given to compounds of the formula IIa,

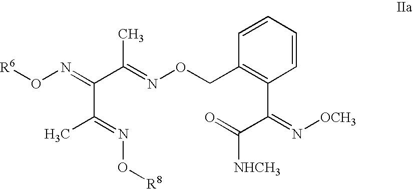

in which R⁶ and R⁸ are methyl, ethyl, isopropyl or cyclopropyl, in particular methyl or ethyl very particular preference is given to the compounds II-1, II-3 and II-5.

Preference is given to fungicidal mixtures which, as component a), comprise one of the compounds: I-33, I-35, I-42, I-44, I-46, I-60, or preferably I-18, I-28, I-37, and, as component b), one of the compounds: II-3, II-5 or preferably II-1.

Owing to the basic character of their nitrogen atoms, the compounds II are capable of forming salts or adducts with inorganic or organic acids or with metal ions.

Examples of inorganic acids are hydrohalic acids such as hydrogen fluoride, hydrogen chloride, hydrogen bromide and hydrogen iodide, carbonic acid, sulfuric acid, phosphoric acid and nitric acid.

Suitable organic acids are, for example, formic acid and alkanoic acids, such as acetic acid, trifluoroacetic acid, trichloroacetic acid and propionic acid, and also glycolic acid, lactic acid, succinic acid, citric acid, benzoic acid, cinnamic acid, oxalic acid, p-toluenesulfonic acid, salicylic acid, p-aminosalicylic acid, 2-phenoxybenzoic acid or 2-acetoxybenzoic acid.

Suitable metal ions are in particular the ions of the elements of the first to'eighth transition groups, especially chromine, manganese, iron, cobalt, nickel, copper, zinc, and additionally those of the second main group, especially calcium and magnesium, of the third and fourth main groups, in particular aluminum, tin and lead. If appropriate, the metals can be present in the various valencies that they can assume.

When preparing the mixtures, it is preferred to employ the pure active compounds I and II, to which further active compounds against harmful fungi or other pests, such as insects, arachnids or nematodes, or else herbicidal or growth-regulating active compounds or fertilizers can be admixed.

The mixtures of the compounds I and II, or the compounds I and II used simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore be employed as foliar- and soil-acting fungicides.

They are especially important for controlling a large number of fungi in a variety of crop plants, such as cotton, vegetable species (e.g. cucumbers, beans, tomatoes, potatoes and cucurbits), barley, grass, oats, bananas, coffee, maize, fruit species, rice, rye, soya, grapevine, wheat, ornamentals, sugar cane, and a variety of seeds.

They are particularly suitable for controlling the following phytopathogenic fungi: Erysiphe graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugar cane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species. They can furthermore be employed in the protection of materials (for example the protection of wood), for example against Paecilomyces variotii.

The compounds I and II can be applied simultaneously, that is either together or separately, or successively, the sequence, in the case of separate application, generally not having any effect on the result of the control measures.

The compounds I and II are usually employed in a weight ratio of from 20:1 to 1:20, in particular from 10:1 to 1:10, preferably from 5:1 to 1:5.

Depending on the kind of effect desired, the application rates of the mixtures according to the invention are, in particular in agricultural crop areas, from 0.01 to 8 kg/ha, preferably 0.1 to 5 kg/ha, in particular 0.1 to 3.0 kg/ha.

The application rates of the compounds I are from 0.005 to 5 kg/ha, preferably 0.08 to 3 kg/ha, in particular 0.06 to 2.0 kg/ha.

Correspondingly, in the case of the compounds II, the application rates are from 0.005 to 3 kg/ha, preferably 0.02 to 2 kg/ha, in particular 0.04 to 1.0 kg/ha.

For seed treatment, the application rates of the mixture are generally from 0.001 to 250 g/kg of seed, preferably 0.01 to 100 g/kg, in particular 0.01 to 50 g/kg.

If phytopathogenic harmful fungi are to be controlled, the separate or joint application of the compounds I and II or of the mixtures of the compounds I and II is effected by spraying or dusting the seeds, the plants or the soils before or after sowing of the plants, or before or after plant emergence.

The fungicidal synergistic mixtures according to the invention or the compounds I and II can be formulated for example in the form of ready-to-spray solutions, powders and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a manner known per se, e.g. by extending the active compound with solvents and/or carriers. The formulations are usually mixed with inert additives such as emulsifiers or dispersants.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compounds I or II or the mixture of the compounds I and II with a solid carrier.

Granules (e.g. coated granules, impregnated granules or homogeneous granules) are usually prepared by binding the active compound, or active compounds, to a solid carrier.

Fillers or solid carriers are, for example, mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers.

The formulations generally comprise from 0.1 to 95% by weight, preferably 0.5 to 90% by weight, of one of the compounds I or II or of the mixture of the compounds I and II. The active compounds are employed in a purity of from 90% to 100%, preferably 95% to 100% (according to NMR spectrum or HPLC).

The compounds I or II, the mixtures, or the corresponding formulations, are applied by treating the harmful fungi, their habitat, or the plants, seeds, soils, areas, materials or spaces to be kept free from them with a fungicidally effective amount of the mixture, or of the compounds I and II in the case of separate application.

Application can be effected before or after infection by the harmful fungi.

### USE EXAMPLE

The synergistic activity of the mixtures according to the invention was demonstrated by the following experiments: The active compounds, separately or together, were formulated as a 10% emulsion in a mixture of 63% by weight of cyclohexanone and 27% by weight of emulsifier, and diluted with water to the desired concentration.

Evaluation was carried out by determining the infected leaf areas in percent. These percentages were converted into efficacies. The efficacy (W) was calculated as follows using Abbot's formula:

W=(1−α)·100/β

α corresponds to the fungal infection of the treated plants in % and

β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the mixtures of the active compounds were determined using Colby's formula [R. S. Colby, Weeds 15, 20-22 (1967)] and compared with the observed efficacies

Colby's formula: E=x+y−x·y/100

E expected efficacy, expressed in % of the untreated control, when using the mixture of the active compounds A and B at the concentrations a and b

x efficacy, expressed in % of the untreated control, when using active compound A at a concentration of a

y efficacy, expressed in % of the untreated control, when using active compound B at a concentration of b

### Use Example 1

### Protective Activity Against Mildew of Cucumbers caused by Sphaerotheca fuliginea

Leaves of cucumber seedlings of the cultivar “Chinesische Schlange” which had been grown in pots were, at the cotyledon stage, sprayed to runoff point with an aqueous preparation of active compound which had been prepared from a stock solution comprising 10% of active compound, 85% of cyclohexanone and 5% of emulsifier. 20 hours after the spray coating had dried on, the plants were inoculated with an aqueous spore suspension of mildew of cucumbers (Sphaerotheca fuliginea). The plants were then cultivated in a greenhouse at temperatures between 20 and 24° C. and at 60 to 80% relative atmospheric humidity for 7 days. The extent of the development of the mildew was then determined visually in % infection of the cotyledon area.

The visually determined values for the percentage of infected leaf areas were converted into efficacies as % of the untreated control. An efficacy of 0 means the same degree of infection as in the untreated control, an efficacy of 100 means 0% infection. The expected efficacies for combinations of active compounds were determined using Colby's formula (Colby, S. R. (Calculating synergistic and antagonistic responses of herbicide Combinations” [sic], Weeds, 15, p. 20-22, 1967) and compared to the observed efficacies.

TABLE A

| | Concentration of active | |
|---|---|---|
| | compound in the spray | Efficacy in % of the |
| Active compound | liquor in ppm | untreated control |
| Control (untreated) | (83% infection) | 0 |
| Compound I-28 | 0.125 | 52 |
| | 0.06 | 3 |
| Compound I-37 | 0.125 | 3 |
| | 0.06 | 3 |
| Compound II-1 | 0.25 | 52 |
| | 0.125 | 52 |

TABLE B

| Combinations | | |
|---|---|---|
| according to the | | |
| invention | Observed efficacy | Calculated efficacy*) |
| Compound I-28 + | 100 | 77 |
| compound II-1 | | |
| 0.125 + 0.125 ppm | | |
| mixture 1:1 | | |
| Compound I-28 + | 94 | 77 |
| compound II-1 | | |
| 0.125 + 0.25 ppm | | |
| mixture 1:2 | | |
| Compound I-28 + | 76 | 53 |
| compound II-1 | | |
| 0.06 + 0.125 ppm | | |
| mixture 1:2.1 | | |
| Compound I-28 + | 100 | 53 |
| compound II-1 | | |
| 0.06 + 0.25 ppm | | |
| mixture 1:4.16 | | |
| Compound I-37 + | 76 | 47 |
| compound II-1 | | |
| 0.125 + 0.125 ppm | | |
| mixture 1:1 | | |
| Compound I-37 + | 60 | 47 |
| compound II-1 | | |
| 0.125 + 0.25 ppm | | |
| mixture 1:2 | | |
| Compound I-37 + | 76 | 47 |
| compound II-1 | | |
| 0.06 + 0.125 ppm | | |
| mixture 1:2, 1 | | |
| Compound I-37 + | 60 | 47 |
| compound II-1 | | |
| 0.06 + 0.25 ppm | | |
| mixture 1:4.16 | | |

*)calculated using Colby's formula

The test results show that in all mixing ratios the observed efficacy is higher than the efficacy which had been calculated beforehand using Colby's formula (from Synerg 166A. XLS).

We claim:

1. A fungicidal mixture, comprising
a) benzophenones of the formula I, 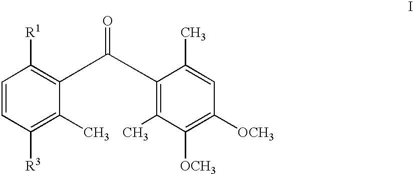
in which
R¹ is methoxy and R³ is chlorine;
R¹ is methoxy and R³ is bromine; or
R¹ is hydroxyl and R³ is chlorine, and
b) a trisoxime ether of the formula II, 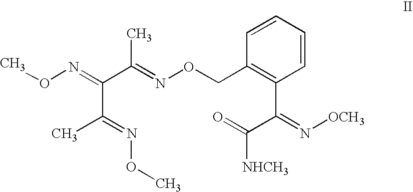
in a synergistically effective amount.

2. A fungicidal mixture as claimed in claim 1, wherein the weight ratio of the benzophenones 1-to the trisoxime ether of the formula II is from 20:1 to 1:20.

3. A method for controlling harmful fungi, which comprises treating the harmful fungi, their habitat or the plants, seeds, soils, areas, materials or spaces to be kept free from them with benzophenones of the formula I as set forth in claim 1 and the trisoxime ether of the formula II as set forth in claim 1.

4. A method as claimed in claim 3, wherein the benzophenones of the formula I as set forth in claim 1 and a trisoxime ether of the formula II as set forth in claim 1 are applied simultaneously, that is either together or separately, or successively.

5. A method as claimed in claim 3 or 4, wherein the benzophenones of the formula I as set forth in claim 1 are applied in an amount of from 0.08 to 3 kg/ha.

6. A method as claimed in any of claims 3 to 5, wherein the trisoxime ethers of the formula II as set forth in claim 1 are applied in an amount of from 0.02 to 2 kg/ha.

7. A composition as claimed in claim 1, which is conditioned in two parts, one part comprising benzophenones of the formula 1 as set forth in claim 1 on a solid or in a liquid carrier and the other part comprising a trisoxime ether of the formula II as set forth in claim 1 on a solid or in a liquid carrier.
